(19) United States
(12) Patent Application Publication
(10) Pub. No.: US 2025/0112768 A1
(43) Pub. Date: Apr. 3, 2025

(54) PROTECTING SENSITIVE DATA IN TEXT-BASED GEN-AI SYSTEM

(71) Applicant: Baffle, Inc., Santa Clara, CA (US)

(72) Inventors: Min-Hank Ho, Santa Clara, CA (US); Priyadarshan Kolte, Santa Clara, CA (US); Palanivel Rajan Shanmugavelayutham, Santa Clara, CA (US); Kishore Kumar Chandrasekaran, Santa Clara, CA (US); Balaji Govindan, Santa Clara, CA (US)

(21) Appl. No.: 18/897,817

(22) Filed: Sep. 26, 2024

Related U.S. Application Data
(60) Provisional application No. 63/540,938, filed on Sep. 28, 2023.
(60) Provisional application No. 63/627,637, filed on Jan. 31, 2024.

(51) Int. Cl. H04L 9/08

(52) U.S. Cl. CPC H04L 9/088

(57) ABSTRACT

A method and system for protecting sensitive data in a generative AI system is disclosed. The method includes encrypting sensitive data fields at a field level using a first encryption proxy in a data store, labeling the encrypted data fields with metadata in the data store, interfacing the data store to the generative AI system, receiving a user prompt at a second proxy, sending the user prompt to the generative AI system, generating a response by the generative AI system, receiving the response from the generative AI system, and selectively decrypting, by the second proxy, sensitive data in the response based on user authorization. In some embodiments, the metadata comprises encryption keys information and access control policies.

### CROSS-REFERENCE TO RELATED APPLICATIONS

This application claims the benefit of U.S. Provisional Application No. 63/540,938, filed on Sep. 29, 2023, the entire contents of which are incorporated by reference.

### TECHNICAL FIELD

The present disclosure relates generally to methods and systems for protecting sensitive data in generative artificial intelligence (AI) applications. The disclosed techniques may be applied to, for example, maintaining data privacy and regulatory compliance while leveraging generative AI capabilities in various industries and applications.

### BACKGROUND

Generative AI systems, powered by large language models (LLMs), have emerged as powerful tools capable of processing and generating human-like responses to natural language prompts. These systems can extract valuable insights from vast pools of seemingly unrelated data, offering unprecedented capabilities in information retrieval and analysis. However, the ability to sift through large datasets to find specific information of interest also presents significant challenges in protecting sensitive, private, or regulated data.

Organizations across various industries are increasingly interested in leveraging generative AI technologies to enhance their operations and decision-making processes. However, they often face a dilemma when considering the use of datasets that may contain regulated or sensitive information. Data privacy regulations and contractual obligations typically require controlled access to such data on a “need-to-know” basis.

Existing approaches to address data security concerns in generative AI systems have focused on filtering techniques, such as pattern matching using regular expressions or employing additional AI systems trained to identify sensitive information based on context. More advanced methods utilize machine learning techniques like Reinforcement Learning from Human Feedback (RLHF) to optimize systems for blocking responses containing sensitive information.

However, these solutions often struggle with accuracy, producing both false positives and false negatives. This can result in the inadvertent disclosure of sensitive information or the unintended blocking of non-sensitive data. Furthermore, the effectiveness of these filtering systems can be compromised by users actively attempting to circumvent them. Simple adjustments to the phrasing of questions can often bypass security measures, exposing weaknesses in current generative AI services. The challenge lies in reliably determining the sensitivity of data solely from the prompt or the response of the generative AI system, as the security context is often lost when data is combined with other information in the Al's training set.

The development of robust, customizable, and deterministic solutions for provably protecting specific sensitive data and providing differentiated levels of access based on authorization remains a significant challenge in the field of generative AI. There is a growing need for innovative approaches that can maintain data privacy and regulatory compliance while still harnessing the powerful capabilities of generative AI systems across various industries and applications.

### BRIEF DESCRIPTION OF DRAWINGS

The accompanying drawings, which are incorporated in and form a part of the specification, illustrate the embodiments of the invention and together with the written description serve to explain the principles, characteristics, and features of the invention. Various aspects of at least one example are discussed below with reference to the accompanying drawings, which are not intended to be drawn to scale. In the drawings:

FIG. 1A depicts an exemplary system for protecting sensitive data in a generative AI application in accordance with an embodiment.

FIG. 1B depicts an illustrative workflow for training a large language model utilizing encrypted and labeled data in accordance with an embodiment.

FIG. 2 depicts an illustrative flowchart of a method for protecting sensitive data in a generative AI system in accordance with an embodiment.

FIG. 3 illustrates a block diagram of an example data processing system in which embodiments are implemented.

### DETAILED DESCRIPTION

This disclosure is not limited to the particular systems, devices and methods described, as these may vary. The terminology used in the description is for the purpose of describing the particular versions or embodiments only and is not intended to limit the scope.

### Overview

Generative AI is poised to alter the way many people use information systems due to its ability to model human-like responses to natural language prompts through the use of large language models (LLMs) trained using huge datasets. Through generative AI systems, a user may easily extract valuable insights from a large pool of seeming unrelated and disparate data. Unfortunately, this ability to sift through large data sets to find a specific dataset of interest may be abused to reveal private, sensitive, or regulated data. Data privacy regulations or contractual obligations may require access to this type of data to be controlled and granted on a “need to know” basis. Thus, companies seeking to use generative AI with datasets that might include regulated and/or controlled data may be confronted with the dilemma of abandoning the effort or running afoul of their legal and contractual obligations. As disclosed herein, a data protection system may solve the problem of enabling a company to retain privacy of their sensitive data while allowing legitimate users controlled access to the insights obtained from generative AI.

Several approaches have been proposed to address security concerns relating to use of generative AI. Some focus on a filtering approach that may identify sensitive information to block using pattern matching such as regular expressions or another AI system trained to figure out sensitivity of data from the context. More sophisticated approaches use machine learning techniques like Reinforcement Learning from Human Feedback (RLHF) to optimize the system to block responses with sensitive information.

All of the aforementioned solutions are known to have false positives and false negatives. This means that they may allow sensitive information to be disclosed or accidentally block access to information that need not be controlled. This may be due to filters not being able to reliably determine whether or not data is sensitive just from the prompt or the response of the generative AI system. The security context for the data may be lost when it is comingled with the pool of other data that is used as the basis for the generative AI system. As a result, these solutions may not prove true assurance that sensitive data is controlled and protected at all times. At the same time, they may also frustrate legitimate users by denying them the ability to use the service for no good reason.

Furthermore, against actual humans that are actively trying to circumvent these filters, the weaknesses of these systems are often quickly exposed and shared with others to reuse. For example, current generative AI services have implemented security filters to prevent users from using them to find dangerous or sensitive content. For example, ways to bypass these filters, by adjusting the way the questions are asked, may be readily available via a simple search.

Finally, the previous solutions are developed with great effort to be generally useful and once released for use are not easy to customize for protecting specific sensitive data and for providing different levels of access to sensitive data for specific users.

In some aspects, a system may address the data security and compliance for generative AI systems by encrypting the data at the field level at the beginning of data pipeline using an inline encryption proxy for the data store. Encrypting at this stage means that there may be more context regarding the nature of the data to decide which data values require protection and ensure that it stays protected throughout the flow of the data through all components of the generative AI system.

More specifically, the decision to encrypt may be defined in a declarative policy at an early stage. For example, a company may define a policy that all social security numbers must be encrypted. The policy may include information about where the social security number is stored in the data store (e.g. table column, JSON field, etc.) as well as how to protect it (e.g. encryption, tokenization, or masking).

When the data is encrypted, an encoded version of the metadata may be stored with the encrypted value to identify, among other information, the keys used to encrypt the data, embedding information, the nature or data (e.g. identifying the data as a social security number), and/or access control policies. In some aspects, the metadata may be used to identify relationships within the data to better contextualize the information to the generative AI system. Effectively, the encrypted data value is simultaneously protected and labeled. The generative AI system is sent encrypted and labeled data for training, fine-tuning, and in prompts for inference.

In some aspects, API-based encryption may be utilized as an alternative to the inline encryption proxy. The encryption APIs may provide various encryption algorithms and key management services, allowing for customization based on specific security requirements. API-based encryption may automatically extract and encode metadata as described herein.

In some aspects, the encryption used in the system may be reversible or non-reversible. Reversible encryption allows the original data to be recovered using a decryption key, which may be useful when authorized users need to access the unencrypted information. Non-reversible encryption, such as one-way hashing, may be employed when the original data does not need to be retrieved. In some cases, metadata can be embedded in synthetic data generated by the system. The metadata may be encoded within the synthetic data in a way that does not compromise the privacy of the original sensitive information. In embodiments featuring synthetic data, metadata based on the original (i.e., non-hashed) may support downstream mathematical or logic operations (e.g. cosine distance) such that the generative AI may produce valid responses.

When the data value is incorporated as part of the response to a given prompt or inference request, the user may access the generative AI application through another proxy that proxies for the web service that would provide the prompt/response interface. The purpose of the proxy may be to decrypt or mask the value for authorized users. The authorization may be determined based on an identity management framework. Example identity management frameworks include OpenID Connect (OIDC) or Security Assertion Markup Language (SAML). The proxy may use customizable policies known as Role Based Access Control (RBAC) to control the level of access for each authorized user or group of users. RBAC policies may be managed centrally to apply to all proxies that are used in the processing of responses to end users

By encrypting the sensitive values, some responses to prompts may differ from those that would be given had the system accessed the cleartext version of the data. However, in most valid or allowed use cases at business, inference responses are not affected by anonymized or encrypted sensitive data values. For example, when asked about controlled information (e.g., someone's personal email address) that was encrypted earlier in the pipeline, the generative AI system may give a natural language response similar to when the controlled information is not encrypted. The difference is that the sensitive information within the natural language response will appears to the user as an encrypted or masked value when the user lacked authorization to see the controlled information.

Some embodiments differ from other solutions for text-based generative AI by identifying sensitive data and enforcing access control at earliest point of data pipelines that feeds generative AI systems rather than applying a filter at the end of the pipeline before the data is sent to the user. Furthermore, by labeling the data at a stage where the nature of the data is better known, the system may perform less guessing as to whether a particular data value is sensitive or regulated. The solution may use two inline proxies, one before data is ingested into the generative AI system, and one before the user prompt is sent to the LLM and after the response is received from the LLM.

The system may apply access control enforcement at a different point in the pipeline, as opposed to traditional systems. In some aspects, the system may use cryptography. Previous approaches avoid using field-level encryption needed to protect data for generative AI systems due to the complexity of having the user implement encryption within new or existing applications, but the disclosed solution may use two inline proxies eliminate the need to make code modification thus reducing complexity.

As a result, sensitive and regulated data may remain protected even if the generative AI gives a response that previously would have been in the clear. Even with adversarial prompting where users succeed in bypassing filters from regular expression pattern match or rules inserted by RLHF, the adversaries may only receive encrypted versions of the sensitive data values. Legitimate users who are granted sufficient access in the RBAC policies may receive useful responses from the generative AI system.

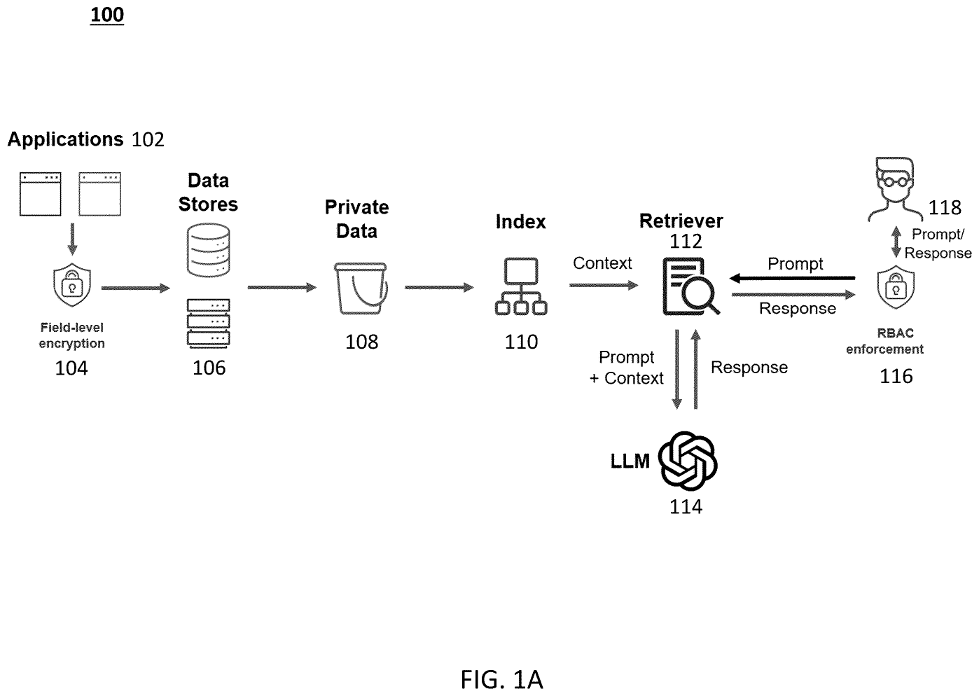

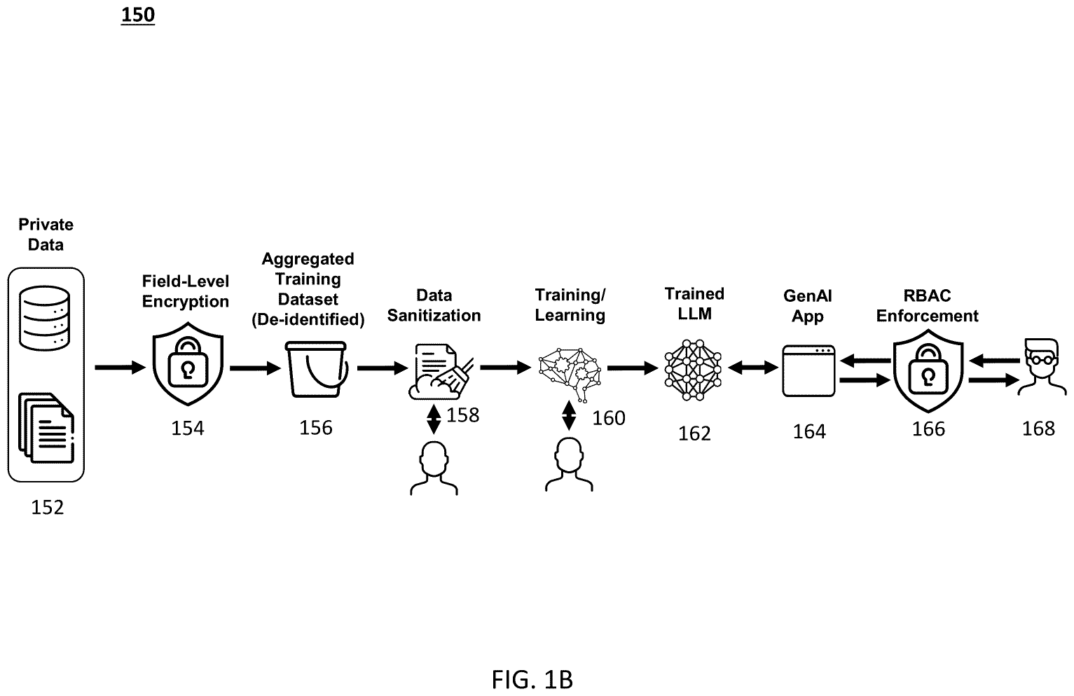

Referring to FIG. 1A, a system 100 for protecting sensitive data in a generative AI application is illustrated in accordance with an embodiment. In some aspects, the system 100 may include applications 102 which provide a dataset to the generative AI. The applications 102 may interface with a field-level encryption component 104. The field-level encryption 104 may be configured to process data before it is stored in data stores 106. In some cases, the field-level encryption 104 may be a first encryption proxy that encrypts sensitive data fields at a field level in the data stores 106.

In some aspects, the applications 102 may be any type of software or hardware systems that generate, process, or handle data. In some cases, the applications 102 may include, but are not limited to, databases, data processing systems, data analytics systems, or other types of data handling systems. The applications 102 may generate or process data that is to be stored in data stores 106.

In some aspects, the data stores 106 may be any type of data storage systems, such as databases, data warehouses, object stores, data lakes, or other types of data storage systems. The data stores 106 may store various types of data, including private data 108. The private data 108 may include sensitive data fields that have been encrypted and labeled by the field-level encryption 104.

In some aspects, the system 100 may analyze the data stores 106 to identify potential sensitive information. The system 100 may employ natural language processing (NLP) algorithms to scan text and recognize patterns that could indicate sensitive data, such as social security numbers, credit card information, or personal health details. Machine learning models may be trained on large datasets of known sensitive information to recognize similar patterns in new data.

Additionally, or alternatively, the system 100 may utilize contextual analysis to identify potentially sensitive information based on the surrounding text or metadata. For example, an AI system may flag data as potentially sensitive if it appears in proximity to keywords like “confidential” or “private.” In some cases, these systems may also incorporate rule-based approaches, combining predefined patterns and contextual understanding to improve accuracy in identifying sensitive information across diverse datasets.

In some embodiments, the system 100 may include a labeling module, which may be part of the field-level encryption 104 or a separate component. The labeling module may be configured to label the encrypted data fields with metadata in the data stores 106. The metadata may include, but is not limited to, information about the encryption keys used, the nature of the data, and/or access control policies.

The data stores 106 may contain private data 108, which is then indexed in an index 110. The index 110 may be a data structure that improves the speed of data retrieval operations on the data stores 106. The index 110 may contain references to the private data 108 in the data stores 106, thereby allowing the system 100 to quickly locate and access the private data 108.

In some cases, the system 100 may include a retriever 112 that accesses the index 110 to obtain context information. The retriever 112 may be a software or hardware component that retrieves data from the data stores 106 based on the index 110. The retriever 112 may interact with the LLM 114, exchanging prompts, context, and responses. The LLM 114 may generate responses based on the provided prompts and context, which may include the encrypted and labeled data.

The data store 106 and private data 108 may include the encrypted and labeled sensitive data fields. The private data 108 may interface with the generative AI system, which may include a Large Language Model (LLM) 114. The LLM 114 may be trained on the encrypted and labeled data from the data stores 106.

In some aspects, the system 100 may be configured to interface the data stores 106 to the generative AI system. This may involve sending the encrypted and labeled data from the data stores 106 to the LLM 114 for context in prompts for inference. The LLM 114 may generate responses based on the provided prompts and context, which may include the encrypted and labeled data, based on an authorization level of a user associated with the prompt.

In some embodiments, the system 100 may be configured to protect sensitive data in a generative AI application by encrypting sensitive data fields at a field level using a first encryption proxy in a data store, labeling the encrypted data fields with metadata in the data store, and interfacing the data store to the generative AI system.

In some cases, the system 100 may include a Role-Based Access Control (RBAC) enforcement component 116 that manages user 118 interactions. In some aspects, the user 118 may send prompts and receive responses through the RBAC enforcement 116, which ensures appropriate access control. The RBAC enforcement 116 may be a second proxy configured to receive user prompts, send the prompts to the LLM 114, receive responses from the LLM 114, and selectively decrypt sensitive data in the responses based on user authorization.

In some cases, the user 118 may interact with the system 100 by sending a user prompt to the RBAC enforcement 116. The RBAC enforcement 116 may then send the user prompt to the LLM 114. The LLM 114, having been trained on the encrypted and labeled data from the data stores 106, may generate a response based on the provided prompt and context. The generated response may then be sent back to the RBAC enforcement 116.

Upon receiving the response from the LLM 114, the RBAC enforcement 116 may selectively decrypt sensitive data in the response based on user authorization. This selective decryption may involve applying different levels of access to different users based on their roles as defined in the RBAC policies. In some aspects, the RBAC enforcement 116 may also selectively mask sensitive data in the responses based on the user authorization. This may involve replacing the sensitive data with a placeholder or other non-sensitive data for unauthorized users. The selective masking may provide an additional layer of protection for sensitive data, ensuring that unauthorized users cannot access the sensitive data even if they are able to bypass other security measures. In some aspects, the levels of access may be associated with labels applied to the encrypted data in the data stores 106.

In some cases, the user authorization may be determined based on identity management frameworks such as OpenID Connect (OIDC) or Security Assertion Markup Language (SAML). The RBAC enforcement 116 may use these frameworks to determine the level of access for each user or group of users. This may allow the system 100 to provide different levels of access to sensitive data for specific users, thereby ensuring that sensitive data is controlled and protected at all times.

In some aspects, the system 100 may utilize field level encryption 104 configured to encrypt sensitive data fields at a field level in the data stores 106. The encryption 104 may be performed at a first proxy. The encryption may be based on a declarative policy that defines which data values require protection. The declarative policy may specify the location of sensitive data in the data store 106 and a protection method for the sensitive data. For instance, the policy may indicate that all social security numbers stored in a particular location of the data store 106 (e.g., a table column or JSON field) should be encrypted. The protection method may include encryption, tokenization, or masking, among others.

In some cases, the system 100 may include a policy engine, which may be part of the first proxy. The policy engine may be configured to define the declarative policy specifying which data values require protection. This allows the system 100 to identify and protect sensitive data at the earliest point of the data pipeline that feeds the LLM 114.

In some embodiments, the field-level encryption 104 may also label the encrypted data fields with metadata. The metadata may include information about the encryption keys used to encrypt the data, the nature of the data, and/or access control policies. For example, the metadata may indicate that a particular data value is a social security number and should be protected. the labeling process may ensure that the sensitive data is usable by other components of the system 100 when authorized. In some aspects, the metadata may be stored with the encrypted data in the data stores 106. This allows the system 100 to retain the security context for the data, even when it is comingled with other data in the data stores 106.

In some embodiments, the system 100 may include a generative AI model, such as the LLM 114, trained on the encrypted and labeled data from the data stores 106. The LLM 114 may generate responses based on the provided prompts and context, which may include the encrypted and labeled data. In some cases, the LLM 114 may interact with the encrypted data in a way that allows it to generate responses containing encrypted data that can only be decrypted by the RBAC enforcement 116 based on RBAC policies.

In some aspects, the system 100 may be configured to protect sensitive data in a generative AI application by encrypting sensitive data fields at a field level using a first encryption proxy in a data store, labeling the encrypted data fields with metadata in the data store, and interfacing the data store to the generative AI system. As a result, the system 100 may provide controlled access to the insights obtained from the generative AI system while retaining the privacy of the sensitive data.

Referring to FIG. 1B, a workflow 150 for training an LLM (e.g., LLM 114) configured for protecting sensitive data is illustrated in accordance with an embodiment. The workflow 150 may begin with private data 152. The private data 152 may be processed through a field-level encryption proxy 154. The field-level encryption proxy 154 may encrypt sensitive data fields at a granular level, ensuring that specific pieces of information are protected while maintaining the overall structure and usability of the data.

An aggregated training dataset 156 may be generated in a format suitable for training the LLM. The training dataset generation 156 may include techniques such as data augmentation, balancing, or other preprocessing steps to enhance the quality and diversity of the training data. In some embodiments, the training dataset is de-identified.

In some aspects, the data sanitization 158 may be performed on the training dataset. Data sanitization 158 may include processing of the dataset to remove any remaining identifiable information and/or patterns that could potentially compromise privacy. The data sanitization 158 may employ various techniques such as anonymization, pseudonymization, or other privacy-preserving transformations.

The sanitized dataset may then be utilized to train 160 the LLM. During this phase, the LLM may be trained on the protected data, learning patterns and relationships without having access to the raw, sensitive information. The training process may utilize techniques such as federated learning or differential privacy to further enhance data protection during model training.

The result of the training phase is a trained LLM 162. This trained model may have learned to generate responses and insights based on the encrypted and sanitized data, without accessing to the original sensitive information.

The trained LLM 162 may interface with an application interface 164, which may serve as the front-end for user interactions. This application interface 164 may provide a user-friendly way for users to interact with the LLM, submitting queries and receiving responses.

Between the application interface 164 and the user 168, an access control proxy 166 may be implemented. This proxy may manage user access and enforce role-based access control (RBAC) policies. The access control proxy 166 may authenticate users, determine their access levels, and selectively decrypt or mask sensitive information in the LLM's responses based on the user's authorization level.

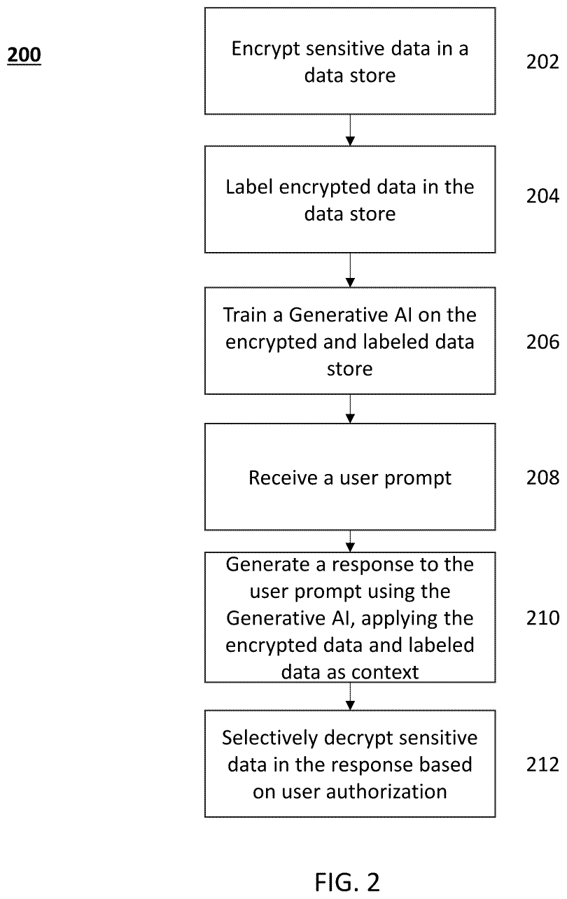

Referring to FIG. 2, a method 200 for protecting sensitive data in a generative AI system is depicted in accordance with an embodiment. In some aspects, the method 200 may include encrypting 202 sensitive data in a data store. The encryption 202 may be performed at a field level using a first encryption proxy, such as the field-level encryption 104 described in relation to FIG. 1A. The encryption 202 may be based on a declarative policy that defines which data values require protection. The declarative policy may specify the location of sensitive data in the data store and a protection method for the sensitive data. For instance, the policy may indicate that all social security numbers stored in a particular table column or JSON field should be encrypted. The protection method may include, for example, encryption, tokenization, or masking.

In some aspects, the method 200 may include labeling 204 the encrypted data is labeled in the data store. The labeling 204 may be performed by a labeling module, which may be part of the first encryption proxy or a separate component. The labeling module may label 204 the encrypted data fields with metadata, which may include information about the encryption keys used, the nature of the data, and/or access control policies. For example, the metadata may indicate that a particular data value is controlled information and should be protected.

In some embodiments, the method 200 may include training 206 a generative AI on the encrypted and labeled data store. The generative AI may be an LLM, such as the LLM 114 described in relation to FIG. 1A. The LLM 114 may be trained 206 on the encrypted and labeled data from the data store, allowing it to generate responses based on provided prompts and context, which may include and/or reference the encrypted and labeled data. In some cases, the LLM 114 may interact with the encrypted data in a way that allows it to generate meaningful responses without revealing the sensitive data.

In alternative embodiments, a the LLM 114 may not be specifically trained on encrypted data.

The method 200 may include receiving 208 a user prompt. The user prompt may be received 208 at a second proxy, for example the RBAC enforcement 116 proxy described in relation to FIG. 1A. The second proxy may send the user prompt to the LLM 114 (e.g., via the receiver 112).

In some aspects, the method 200 may include generating 210 a response to the user prompt using the Generative AI. The generated 210 response may then be sent back to the second proxy (e.g., via the receiver 112). The encrypted data may be utilized in the response by utilizing the labeled data as context.

In some embodiments, the method 200 may include selectively decrypting 212 sensitive data in the response based on user authorization. This selective decryption 212 may be performed by the second proxy, which may decrypt the sensitive data for authorized users while leaving the sensitive data encrypted for unauthorized users. In some cases, the second proxy may also selectively mask sensitive data in the responses based on the user authorization. This may involve replacing the sensitive data with a placeholder or other non-sensitive data for unauthorized users.

In some embodiments, the method 200 may be configured to protect sensitive data in a generative AI system by encrypting sensitive data fields at a field level using a first encryption proxy in a data store, labeling the encrypted data fields with metadata in the data store, training a Generative AI on the encrypted and labeled data store, receiving a user prompt at a second proxy, generating a response to the user prompt using the Generative AI, and selectively decrypting sensitive data in the response based on user authorization. The method 200 may provide controlled access to the insights obtained from the generative AI system while retaining the privacy of the sensitive data.

### Example Computing Device

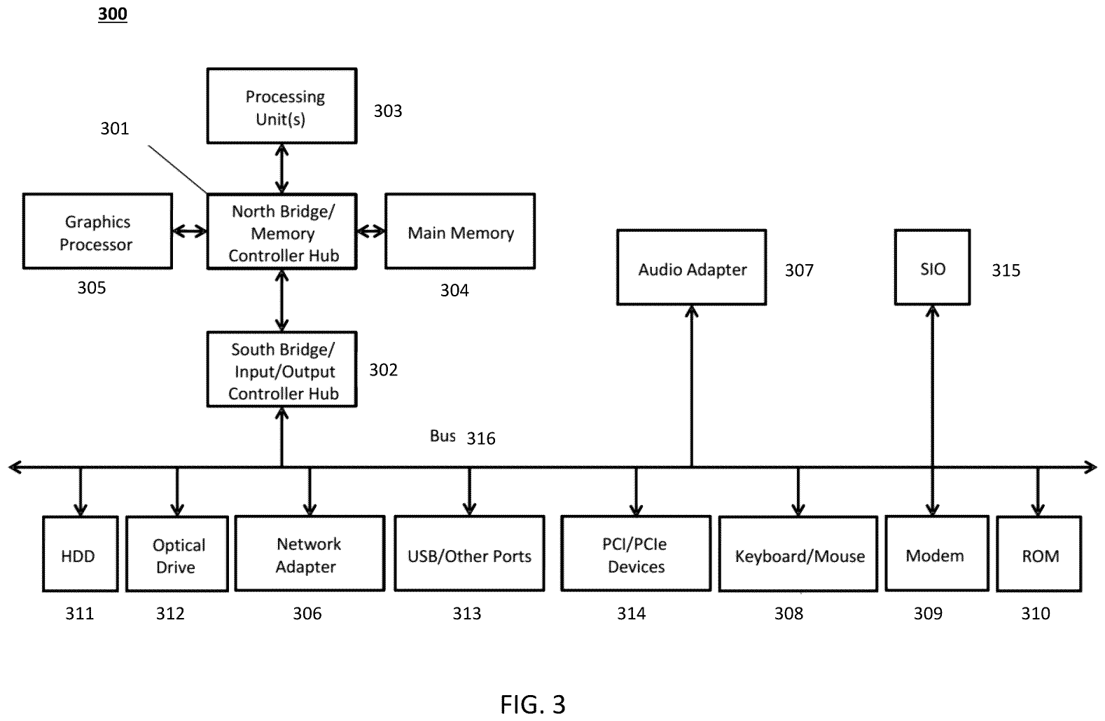

FIG. 3 illustrates a block diagram of an example data processing system 300 in which embodiments are implemented. The data processing system 300 is an example of a computer, such as a server or client, in which computer usable code or instructions implementing the process for illustrative embodiments of the present invention are located. In some embodiments, the data processing system 300 may be a server computing device. For example, the data processing system 300 may be implemented in a server or another similar computing device operably connected to the databases 106/18 as described above. The data processing system 300 may be configured to, for example, perform processing associated with applications 102, proxies 104/116, data stores 106, retriever 112, and/or LLM 114.

In the depicted example, the data processing system 300 may employ a hub architecture including a north bridge and memory controller hub (NB/MCH) 301 and south bridge and input/output (I/O) controller hub (SB/ICH) 302. A processing unit 303, a main memory 304, and a graphics processor 305 may be connected to the NB/MCH 301. The graphics processor 305 may be connected to the NB/MCH 301 through, for example, an accelerated graphics port (AGP).

In the depicted example, a network adapter 306 connects to the SB/ICH 302. An audio adapter 307, a keyboard and mouse adapter 308, a modem 309, a read only memory (ROM) 310, a hard disk drive (HDD) 311, an optical drive (e.g., CD or DVD) 312, a universal serial bus (USB) ports and other communication ports 313, and PCI/PCIe devices 314 may connect to the SB/ICH 302 through a bus system 316. The PCI/PCIe devices 314 may include Ethernet adapters, add-in cards, and/or PC cards for notebook computers. The ROM 310 may be, for example, a flash basic input/output system (BIOS). The HDD 311 and the optical drive 312 may use an integrated drive electronics (IDE) or serial advanced technology attachment (SATA) interface. A super I/O (SIO) device 315 may be connected to the SB/ICH 302.

An operating system may run on the processing unit 303. The operating system may coordinate and provide control of various components within the data processing system 300. As a client, the operating system may be a commercially available operating system. An object-oriented programming system, such as the Java™ programming system, may run in conjunction with the operating system and provide calls to the operating system from the object-oriented programs or applications executing on the data processing system 300. As a server, the data processing system 300 may be an IBM® eServer™ System® running the Advanced Interactive Executive operating system or the Linux operating system. The data processing system 300 may be a symmetric multiprocessor (SMP) system that can include a plurality of processors in the processing unit 303. Alternatively, a single processor system may be employed.

Instructions for the operating system, the object-oriented programming system, and applications or programs are located on storage devices, such as the HDD 311, and are loaded into the main memory 304 for execution by the processing unit 303. The processes for embodiments described herein may be performed by the processing unit 303 using computer usable program code, which can be located in a memory such as, for example, main memory 304, ROM 310, or in one or more peripheral devices.

A bus system 316 may comprise one or more busses. The bus system 316 may be implemented using any type of communication fabric or architecture that provides for a transfer of data between different components or devices attached to the fabric or architecture. A communication unit such as the modem 309 or the network adapter 306 may include one or more devices that can be used to transmit and receive data.

Those of ordinary skill in the art will appreciate that the hardware depicted in FIG. 3 may vary depending on the implementation. Other internal hardware or peripheral devices, such as flash memory, equivalent non-volatile memory, or optical disk drives may be used in addition to or in place of the hardware depicted. Moreover, the data processing system 300 can take the form of any of a number of different data processing systems, including but not limited to, client computing devices, server computing devices, tablet computers, laptop computers, telephone or other communication devices, personal digital assistants, and the like. Essentially, data processing system 300 can be any known or later developed data processing system without architectural limitation.

### CONCLUSION

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

As disclosed herein, features consistent with the present inventions may be implemented by computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory, embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks by one or more data transfer protocols (e.g., HTTP, FTP, SMTP, and so on).

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is also to be understood that the terminology used herein is for the purpose of describing particular embodiments only and is not intended to be limiting.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed:

1. A method for protecting sensitive data in a generative AI system, comprising:
encrypting sensitive data fields at a field level using a first encryption proxy in a data store;
labeling the encrypted data fields with metadata in the data store;
interfacing the data store to the generative AI system;
receiving a user prompt at a second proxy;
sending the user prompt to the generative AI system;
generating a response by the generative AI system;
receiving the response from the generative AI system; and
selectively decrypting, by the second proxy, sensitive data in the response based on user authorization.

2. The method of claim 1, wherein the metadata comprises encryption keys information and access control policies.

3. The method of claim 1, wherein encrypting sensitive data fields is based on a declarative policy defining which data values require protection.

4. The method of claim 3, wherein the declarative policy specifies a location of sensitive data in the data store and a protection method for the sensitive data.

5. The method of claim 1, wherein user authorization is determined based on identity management frameworks comprising at least one of OpenID Connect (OIDC) or Security Assertion Markup Language (SAML).

6. The method of claim 5, further comprising applying Role Based Access Control (RBAC) policies to control a level of access for each authorized user or group of users.

7. The method of claim 6, wherein selectively decrypting sensitive data comprises applying different levels of access to different users based on their roles as defined in the RBAC policies.

8. The method of claim 1, wherein selectively decrypting further comprises selectively masking, by the second proxy, the sensitive data in the response based on the user authorization.

9. A system for protecting sensitive data in a generative AI application, comprising:
a first encryption proxy configured to encrypt sensitive data fields at a field level in a data store;
a labeling module configured to label the encrypted data fields with metadata;
a generative AI model utilizing the encrypted and labeled data for context; and
a second proxy configured to:
receive user prompts,
send the prompts to the generative AI model,
receive responses from the generative AI model, and
selectively decrypt sensitive data in the responses based on user authorization.

10. The system of claim 9, wherein the metadata includes information about encryption keys used, nature of the data, and access control policies.

11. The system of claim 9, further comprising a policy engine configured to define a declarative policy specifying which data values require protection.

12. The system of claim 11, wherein the declarative policy specifies a location of sensitive data in the data store and a protection method for the sensitive data.

13. The system of claim 9, wherein the second proxy is further configured to determine user authorization based on identity management frameworks including OpenID Connect (OIDC) or Security Assertion Markup Language (SAML).

14. The system of claim 13, further comprising a Role Based Access Control (RBAC) module configured to control a level of access for each authorized user or group of users.

15. The system of claim 14, wherein the proxy interface is configured to apply different levels of access to different users based on their roles as defined in the RBAC module when selectively decrypting or masking sensitive data in the responses.

16. The system of claim 9, wherein the second proxy is further configured to selectively mask sensitive data in the responses based on the user authorization.

17. A method for training a generative AI system to protect sensitive AI, comprising:
encrypting sensitive data fields at a field level using a first encryption proxy in a data store;
labeling the encrypted data fields with metadata in the data store;
sanitizing the data store to generate a training dataset; and
training the generative AI system on training dataset.

18. The method of claim 17, wherein the metadata comprises encryption keys information and access control policies.

19. The method of claim 17, wherein encrypting sensitive data fields is based on a declarative policy defining which data values require protection.

20. The method of claim 19, wherein a declarative policy specifies a location of sensitive data in the data store and a protection method for the sensitive data.
